(19) United States
(12) Patent Application Publication
(10) Pub. No.: US 2025/0277508 A1
(43) Pub. Date: Sep. 4, 2025

(54) Telescopic Guide

(71) Applicant: igus GmbH, Köln (DE)

(72) Inventor: Muhammet Erkam Türker, Nörvenich (DE)

(21) Appl. No.: 18/859,087

(22) PCT Filed: Apr. 21, 2023
(86) PCT No.: PCT/EP2023/060505

§ 371 Date: Oct. 22, 2024

(30) Foreign Application Priority Data
Apr. 22, 2022 (DE) 20 2022 102 165.1

(51) Int. Cl. F16C 29/00

(52) U.S. Cl. CPC F16C 29/005; F16C 29/008

(57) ABSTRACT

A telescopic guide (1) includes a first elongated telescopic element (2) as a base element (2a) and second elongated telescopic element (3) as an end element (3a). These these two telescopic elements are arranged parallel to each other and are movable relative to each other in the longitudinal direction. The telescopic guide further includes, a plain bearing indirectly or directly between the first telescopic element (2) and the second telescopic element (3), with the proviso, that the plain bearing has a first plain bearing unit with at least one plain bearing element (26, 27, 26′, 27′) which can be fixed stationary to the first telescopic element (2) and is in sliding contact with the second telescopic element (3), and a second plain bearing unit has at least one plain bearing element (37) which can be fixed stationary to the second telescopic element (3), whereas it is in sliding contact with the first telescopic element (2). The plain bearing elements (26, 27, 26′, 27′, 37) are designed as sleeve-shaped plain bearing bodies (51, 61) which have a C-shaped cross section (52, 62), and wherein a lateral opening (53, 63) is formed on the plain bearing body (51, 61) by means of the C-shaped cross section.

The invention relates to a telescopic guide comprising a first elongated telescopic element as a base element and comprising a second elongated telescopic element as an end element, wherein these two telescopic elements are arranged parallel to each other and are movable relative to each other in the longitudinal direction, wherein a plain bearing is provided indirectly or directly between the first telescopic element and the second telescopic element, with the proviso that the plain bearing has a first plain bearing unit with at least one plain bearing element which can be fixed stationary to the first telescopic element and is in sliding contact with the second telescopic element, and a second plain bearing unit has at least one plain bearing element which can be fixed stationary to the second telescopic element, whereas it is in sliding contact with the first telescopic element.

A generic telescopic guide is known from the utility model DE 20 2018 104 466 U1. This telescopic guide has telescopic elements each with two rails running parallel. For the plain bearing of two telescopic elements four plain bearing elements are provided, of which two are fixed to the first telescopic element and are in sliding contact with the second telescopic element and two plain bearing elements are fixed to the second telescopic element and are in sliding contact with the first telescopic element.

The known structure provides several so-called sliding guide surfaces in order to provide the telescopic mobility of the telescopic elements relative to each other. The design of the plain bearing elements, which are all to be structurally identical, is characteristic of this state of the art. That is to say only a single type of plain bearing element is used universally. The universal plain bearing element is used both on the left and on the right of the double rail and moreover must be fixable either to the first telescopic element or to the second telescopic element. Suitable fixing means must be provided twice for this purpose, which is realized in the form of two recesses which have to cooperate with a separate clamping element. In the fixed state on the telescopic element the applied clamping element forms a raised shape, which fits into one of the recesses of the plain bearing element in a positive-locking manner. The clamping element can be, e.g., a set screw, which can be screwed onto the telescopic element.

The known telescopic guide is considered to protrude too much spatially and to be structurally too elaborate. The universal sliding element is regarded as too complex. In addition, the application of the clamping elements to the telescopic elements is labour-intensive. In particular, if there is a set screw present as clamping element which has to be screwed into the telescopic element parallel to the longitudinal extent. A large amount of effort is expended in order to screw the required number of set screws onto the respective telescopic element in the necessary position.

The object of the invention is to propose a more compact telescopic guide which can be produced with smaller material outlay, requires less installation space and is easier to mount.

According to the invention, the object is achieved in that the plain bearing elements are designed as sleeve-shaped plain bearing bodies which have a C-shaped cross section, and in that a lateral opening is formed on the plain bearing body by means of the C-shaped cross section.

The novel sleeve-shaped plain bearing bodies with the C-shaped cross section eliminate the complexity of the known plain bearing body. The significantly smaller space requirement for the plain bearing bodies is accompanied by the fact that the design of the telescopic elements is also simplified, they are constructed more compact and overall less material is required. The proposed telescopic guide is easier to mount and easier to handle.

The C-shaped cross section of the sleeve-shaped plain bearing bodies always brings about a positive-locking connection together with and relative to the two telescopic elements involved.

The plain bearing thus provided absorbs forces from all directions in the cross-sectional plane of the plain bearing bodies.

Each sleeve-shaped plain bearing body expediently has an inner contour and an outer contour, wherein the inner contour and the outer contour extend in an axial direction of the plain bearing body, and wherein the inner contour and the outer contour are arranged concentric to each other. This design promotes the compactness of the plain bearing bodies.

The inner contour of the plain bearing body advantageously has a polygonal cross section and the cross section is preferably square. The polygonal design promotes the fulfilling of a supporting and guiding function in cooperation with the telescopic elements involved.

It is likewise useful if the outer contour of the plain bearing body has a polygonal or circular cross section. The polygonal design of the outer contour can promote a supporting and guiding function well in cooperation with the telescopic elements involved, whereas a circular cross section is favourable provided that no torque has to be absorbed.

The invention in particular provides two types of plain bearing elements, which have differently designed plain bearing bodies. A differentiated structure is provided instead of a universal plain bearing element. Each type of plain bearing element/plain bearing body has only those functional features which are required during operation.

The first type of plain bearing body is favourably designed such that its inner contour is set up as a plain bearing surface and its outer contour is formed with a fixing means for the stationary fixing to a telescopic element.

In addition, it is useful if the second type of plain bearing body is designed such that its outer contour is set up as a plain bearing surface and its inner contour is formed with a fixing means for the stationary fixing to a telescopic element.

The structure of both types of plain bearing bodies differs in the arrangement of the plain bearing surfaces, which are provided either on the inner contour or on the outer contour. Along with this the respectively other contour (inner or outer contour) serves for fixing the plain bearing body to one of the telescopic elements. A universal design of a single type of plain bearing element or plain bearing body is dispensed with.

The telescopic elements are expediently provided with complementary means which are set up to cooperate with a fixing means of a plain bearing body.

It is helpful, for example for the mounting, if the opening of the C-shaped cross section of the plain bearing body can be temporarily enlarged by means of elastic deformation of the plain bearing body.

A further usefulness is seen if the first elongated telescopic element provided as the base element is provided with a supporting rail, and that the supporting rail has either a cross section with a raised rail head or a cross section with a rail channel.

It is also advantageous if the second elongated telescopic element provided as the end element is provided with a sliding rail, wherein the sliding rail, complementary to the supporting rail of the first elongated telescopic element, has either a cross section with a raised rail head or a cross section with a rail channel.

In principle, the supporting rail in each case cooperates with the sliding rail in such a way that these two are movable translationally relative to each other. Expediently, the supporting rail is static and bears the load and the sliding rail moves on the supporting rail. For this purpose, both complementary rails have cross sections such as, for example, the raised rail head mentioned and the rail channel. The rail head is preferably provided on the supporting rail directed upwards and the rail channel is on the sliding rail with the opening of the channel cross section directed downwards. It is expedient if the rail head and the rail channel are not directly in contact, but rather a plain bearing is provided between these two, which can be provided in the form of the described two types of plain bearing bodies.

The area of application can be improved if the cross section of the rail channel surrounds/envelops the cross section of the allocated rail head in a positive-locking manner in such a way that the rail channel cannot be laterally or upwardly separated from the rail head. The rail head and the rail channel can be separated by reciprocal displacement in the longitudinal direction.

In order to provide the positive-locking envelopment, the rail channel expediently surrounds the rail element in a circumferential range of from 200° to 320°, preferably 270° to 300°, particularly preferably 280° to 290°. If a plain bearing element is interposed, the enveloped circumferential range of the rail channel around the rail head and the enveloped circumferential range of the plain bearing element around the rail head are then identical or almost identical.

A further usefulness is seen if the cross section of the raised rail head is designed complementary to the inner contour of the plain bearing bodies and the cross section of the rail channel is designed complementary to the outer contour of the plain bearing bodies. Through this measure the supporting rail and the sliding rail in each case act, with their raised rail heads or with the rail channels, respectively, as a supporting base for the holder for the plain bearing bodies. The plain bearing bodies in this way obtain a support and guide.

A further usefulness is seen if in each case the first type of plain bearing body, the outer contour of which is provided with the fixing means that serves for the stationary fixing to the respective telescopic element, can be applied to a telescopic element which comprises a supporting rail with a raised rail head or a sliding rail with a raised rail head.

Equally, it is useful if in each case the second type of plain bearing body, the inner contour of which is provided with the fixing means which serves for the stationary fixing to the respective telescopic element, can be applied to a telescopic element which comprises a supporting rail with a rail channel or a sliding rail with a rail channel.

The area of application of the proposed telescopic guide can be expanded if at least one third elongated telescopic element is provided as an intermediate element. The intermediate element is to be viewed as a second telescopic element in relation to the base element, which represents the first telescopic element. In relation to the end element, on the other hand, the intermediate element can be referred to as the first telescopic element, which then serves as a base for the end element as the second telescopic element.

It is helpful if the intermediate element comprises a sliding rail which cooperates with the supporting rail of the base element and the intermediate element for its part comprises a supporting rail which cooperates with the sliding rail of the end element.

The intermediate element further designed in this way can be connected in a positive-locking and sliding manner to the base element and in a positive-locking and sliding manner to the end element. Moreover, two or more intermediate elements can be connected one above the other, with the result that they can cooperate in a positive-locking and sliding manner. In this way, the telescopic guide can be expanded by further telescopic elements in the form of intermediate elements.

An additional improvement is achieved if the telescopic elements are in each case formed as a double rail, wherein the double rail has two parallel supporting rails and/or two parallel sliding rails.

For an intermediate element formed as a double rail it is expediently provided to arrange two double rails one above the other, of which one is designed with parallel sliding rails and is facing towards the base element and the other is designed with parallel supporting rails and is facing towards the end element.

Advantageously, in the case of a double rail, a lateral guiding can be brought about in each case between one of the parallel rails (supporting rail or sliding rail) and the allocated plain bearing bodies, whereas a lateral play (air) is provided between the plain bearing bodies of the other of the parallel rails.

The base element is expediently provided with a stand. The telescopic guide can thus be installed lying (horizontally). However, it can also be installed upright (vertically). Drawer runners are a possible application.

In addition, the base element can have two side elements, wherein the side elements expediently have a height which is sufficient to enclose the telescopic element(s) arranged above them laterally. Such side elements serve at least for mechanical protection and can prevent contamination.

Furthermore, it is useful if at least one of the side elements is formed as a closed side wall. This improves the protection from contamination of the interior of the telescopic guide.

For the end element, it is helpful if it has a mounting plane for any attachments.

The mounting plane can beneficially be a closed surface. The interior of the telescopic guide can thereby be protected from contamination.

At least one of the telescopic elements is expediently formed in a single piece, preferably of metal, particularly preferably of aluminium or an aluminium alloy. Aluminium or an aluminium alloy can be produced by extrusion moulding. This size accuracy and dimensional accuracy as well as the quality of the thus-achievable surfaces are sufficient for telescopic elements. In particular, the areas of extrusion-moulded telescopic elements that are required as sliding surfaces also have sufficient size and dimensional stability as well as sufficient surface quality. The aluminium material expediently has an anodized surface.

All telescopic elements of the telescopic guide preferably have a uniform overall length. An extension length, which is a fraction of this overall length, is provided between two telescopic elements. This extension length preferably lies in a range of 30%-70% of the overall length, preferably 50% of the overall length of a telescopic element.

The sleeve-shaped plain bearing bodies, with their lateral opening, can be produced from plastic, preferably in the form of polymer sliding material, particularly preferably from such a sliding material with a reinforcing filler, such as fibres of plastic or textile.

By a sliding material is meant in the present case a polymer material which has a lower coefficient of friction than the surface of the telescopic element that serves as sliding surface. In particular, this includes the thermoplastics polyethylene, polypropylene, polyacetal, polycarbonate, polyamide, polyvinyl chloride, polytetrafluoroethylene as well as, in the case of thermosets, phenolic resins. To further reduce the friction, these plastics can contain lubricants, in particular fine-particle solid lubricants such as molybdenum disulfide or graphite. Such polymers are also referred to as tribopolymers. With the friction, the wear reduces and the abrasion becomes less. These products are therefore advisable particularly when high purity is important. This is the case for example in the food industry and semiconductor industry, as well as in biochemical and microbiological applications. As mentioned, these polymer materials can furthermore contain fillers and fibrous materials, for example those made of plastic or textile, which improve the mechanical properties.

The proposed telescopic guide can be made very solidly, in particular, when a combination of plastic and aluminium materials is used.

The telescopic elements are more commonly subject to bending in use. For this reason, they are produced from a material which has a high bending stiffness, preferably from a metal, such as the aluminium material mentioned.

In an application as a drawer runner installed upright, it has been shown in a laboratory test that two telescopic guides with an extension length of 400 mm in close proximity withstand a static load of up to 180 N.

Through the use of aluminium material, the telescopic guide benefits from an even further reduced overall weight. In addition, it has a very good resistance to corrosion. Its plain bearing does not require a lubricant. Because lubricants are dispensed with, dirt cannot adhere to components of the telescopic guide, which promotes operational reliability. Any dirt lying thereon can be removed with high-pressure cleaners and/or using cleaning agents. The telescopic guide is therefore low-maintenance and cost-effective.

The invention is illustrated by way of example in a drawing and described in detail with reference to several figures below. There are shown in:

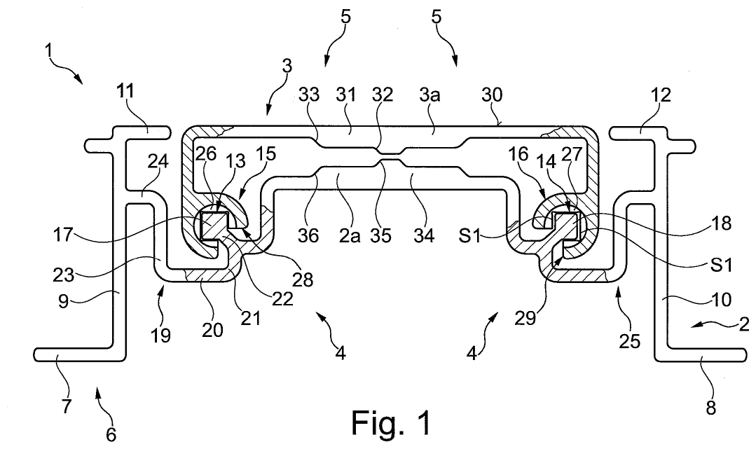

FIG. 1 a front view of a first embodiment example of the telescopic guide according to the invention with two telescopic elements,

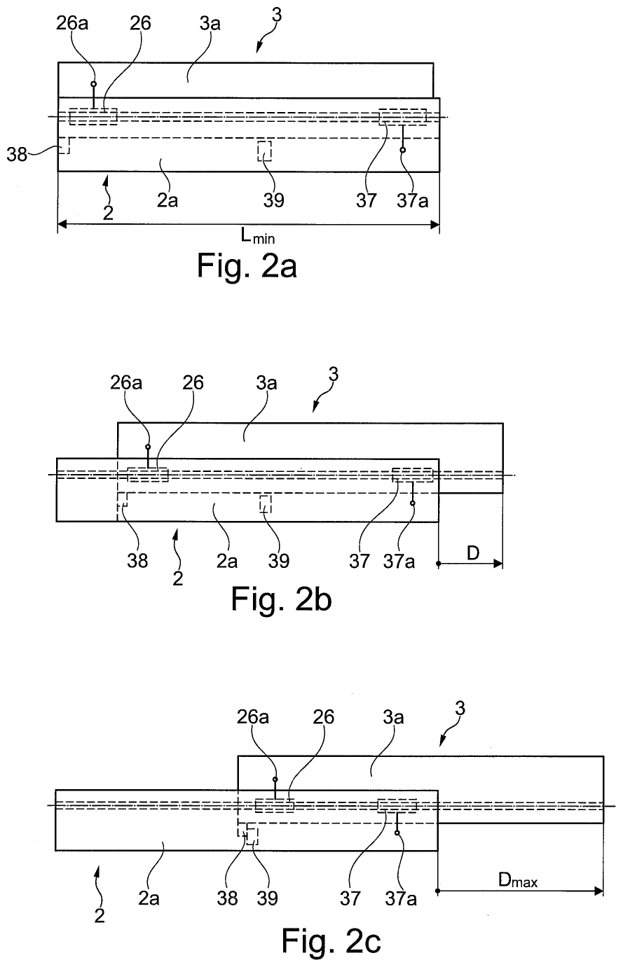

FIG. 2a a schematic side view of the telescopic guide according to FIG. 1 in the retracted state,

FIG. 2b a schematic side view of the telescopic guide according to FIG. 1 in a partially extended state,

FIG. 2c a schematic side view of the telescopic guide according to FIG. 1 in the maximally extended state,

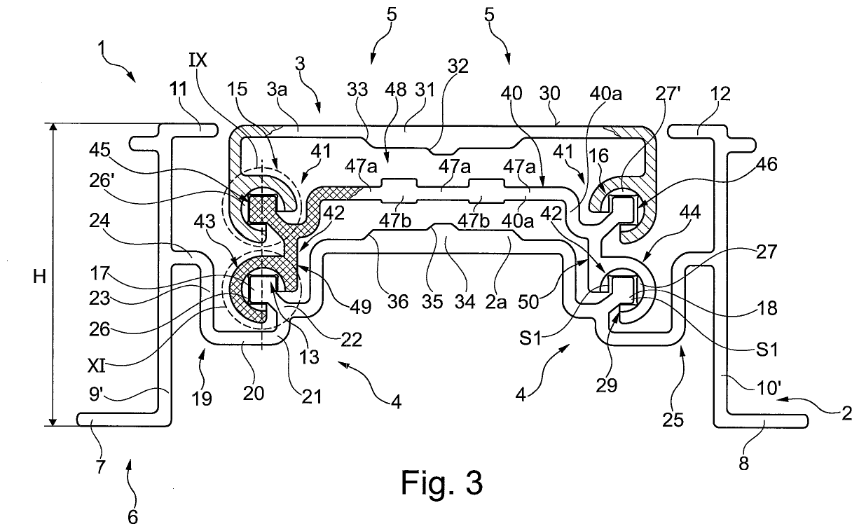

FIG. 3 a front view of a second embodiment example of the telescopic guide according to the invention with three telescopic elements,

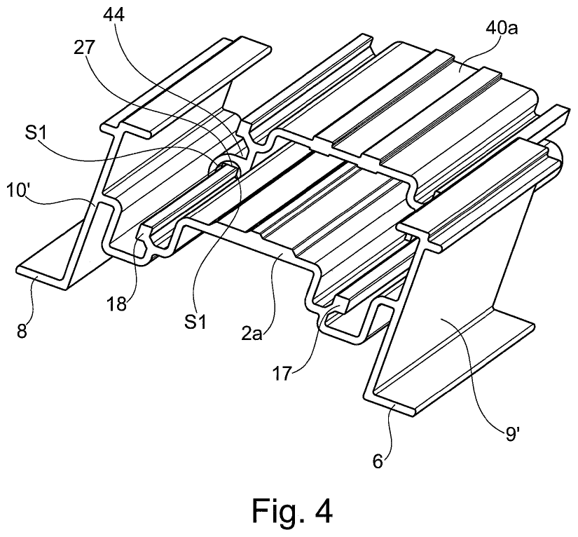

FIG. 4 a perspective view of the rear side of the second embodiment example without the upper telescopic element,

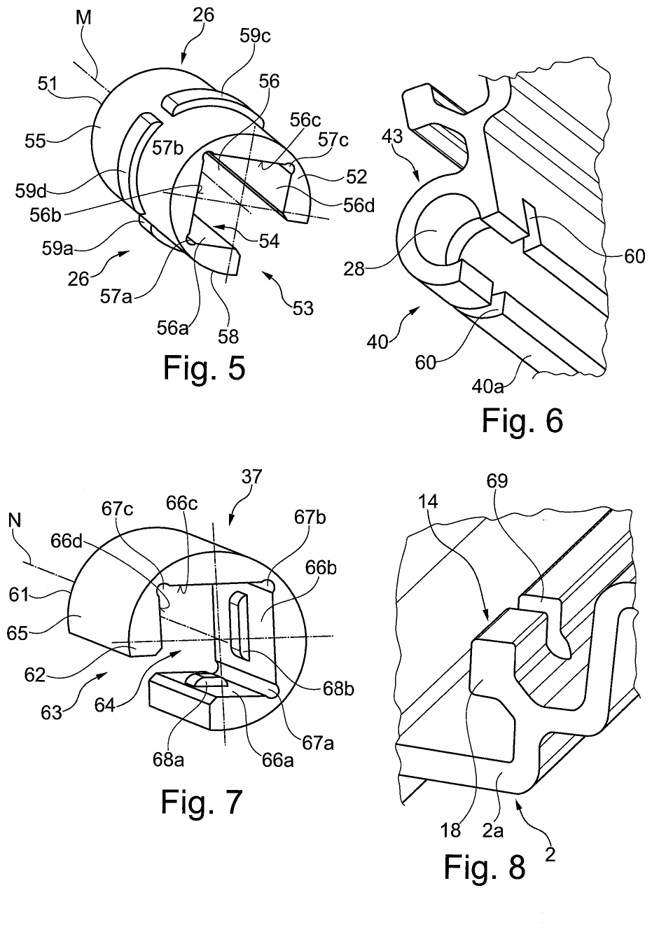

FIG. 5 a perspective view of a plain bearing element with a sleeve-shaped plain bearing body, which has inwardly lying plain bearing surfaces and outwardly lying positive-locking fixing means,

FIG. 6 a perspective section of a telescopic element with complementary means, which are set up for the external fixing means of the plain bearing element according to FIG. 5,

FIG. 7 a perspective view of a plain bearing element with a sleeve-shaped plain bearing body, which has outwardly lying plain bearing surfaces and inwardly lying positive-locking fixing means,

FIG. 8 a perspective section of a telescopic element with complementary means, which are set up for the internal fixing means of the plain bearing element according to FIG. 7,

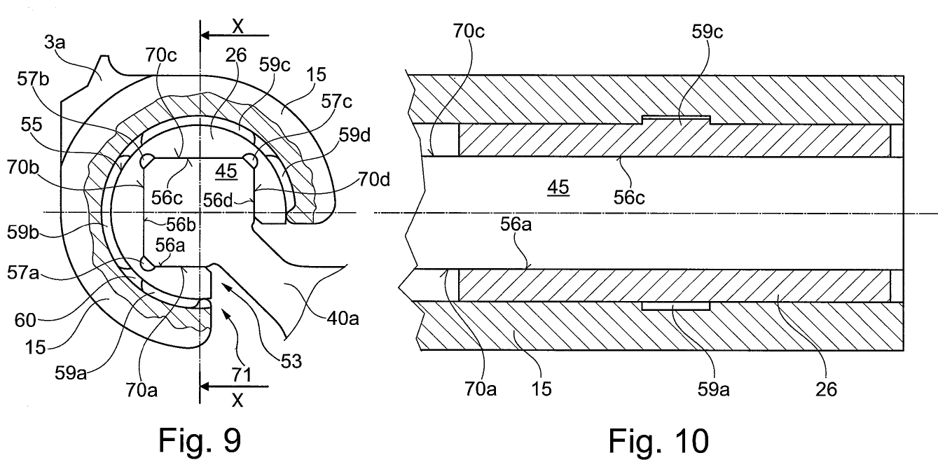

FIG. 9 a detail view according to IX in FIG. 3,

FIG. 10 a detail view according to X in FIG. 9,

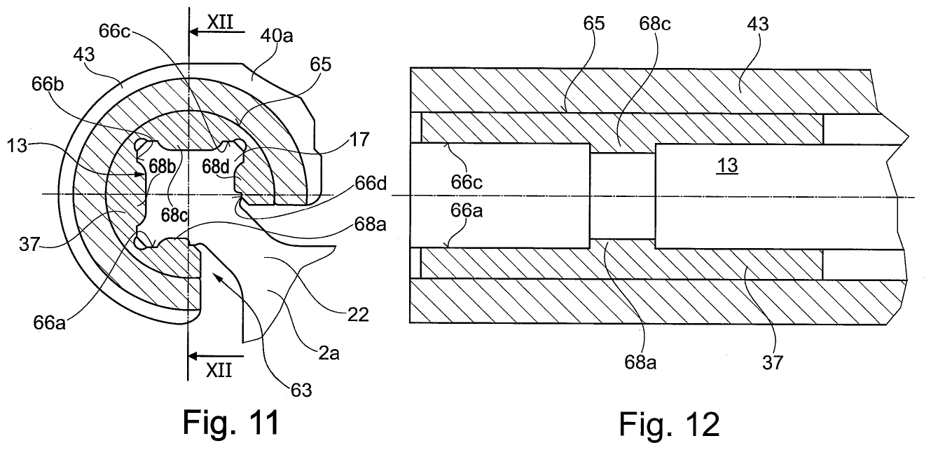

FIG. 11 a detail view according to XI in FIG. 3,

FIG. 12 a detail view according to XII in FIG. 11,

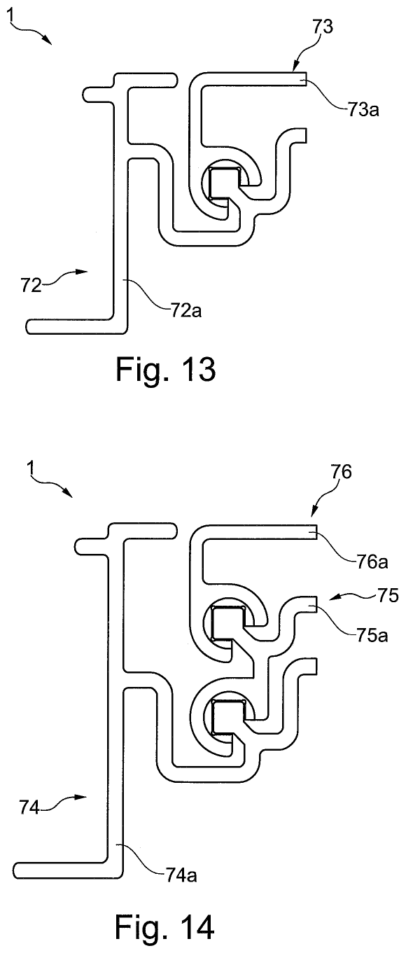

FIG. 13 a third embodiment example of the telescopic guide according to the invention with two telescopic elements,

FIG. 14 a fourth embodiment example of the telescopic guide according to the invention with three telescopic elements.

FIG. 1 shows a first embodiment example of the telescopic guide 1 according to the invention, namely a view from the front. According to this, the telescopic guide 1 comprises two elongated telescopic elements 2 and 3, namely a base element 2a arranged at the bottom and an end element 3a arranged above it which forms the second elongated telescopic element 3. These two telescopic elements are arranged parallel to each other and are movable relative to each other in a longitudinal direction. The longitudinal direction runs orthogonal relative to the plane of this front view.

The telescopic elements 2 and 3 of this embodiment example are in each case formed as a double rail 4 and 5, respectively. The base element 2 is constructed symmetrically. It is provided with a stand 6, which has symmetrical base plates 7 and 8, side walls 9 and 10 and upper ledges 11 and 12. The base plates serve to position or mount the telescopic guide 1 on a surface. Furthermore, the base element 2a has two supporting rails 13 and 14, which are directed upwards relative to the stand 6. The supporting rails 13 and 14 cooperate with sliding rails 15 and 16 of the end element 3a. For this purpose, the supporting rails are in each case provided with a quadrilateral cross section, which forms a raised rail head 15 and 16, respectively. The supporting rail 13 is connected to the side wall 9 of the base element 2a by means of a holding bar 19. The holding bar 19 has a lower crosspiece 20, on which a holding piece 21 is arranged reaching upwards. The holding piece 21 is provided with an inclined holding arm 22, on which the quadrilateral cross section of the rail head 17 is formed. Furthermore, the holding bar 19 has a central piece 23, which is arranged parallel to the side wall 9 of the base element 2a and at an upper end has an upper connecting bar 24 which reaches to the side wall 9 of the base element 2a. The upper connecting bar 24 meets the side wall 9 orthogonally and lies slightly higher than the quadrilateral cross section of the rail head 17. The holding bar 19 is formed in a single piece with the supporting rail 13 and the base element 2a. The supporting rail 14 of the other side is likewise formed in a single piece with the base element 2a by means of a symmetrically constructed holding bar 25.

A plain bearing element 26 sits on the rail head 17 and a plain bearing element 27 sits on the other rail head 18. Each of the plain bearing elements 26/27 for its part has a quadrilateral inner contour and has a circular outer contour. The plain bearing elements 26/27 are identical. In principle, however, two different types of plain bearing elements are provided, which are described in detail further below with reference to FIG. 5 and FIG. 7.

It can furthermore be seen with reference to FIG. 1 that the two sliding rails 15 and 16 of the end element 3a are implemented as sliding channel 28 and sliding channel 29 respectively.

The rail head 18 of the supporting rail 14 is formed slightly narrower than the rail head 17 of the supporting rail 13. The rail head 18 thereby maintains a certain lateral play S1 (air). The rail head 17 of the supporting rail 13, together with the allocated plain bearing elements 26, therefore undertakes the lateral guiding, while the rail head 18 of the supporting rail 14 can compensate, to some extent, for any dimensional deviations in the gauge of the double rail and/or any deviations from the ideal parallelism of the supporting rails. In the case of a horizontal use of the proposed telescopic guide, the rail head 18 together with the supporting rail 14 can bear a portion of an applied load, but without providing lateral guiding.

The end element 3a is provided right at the top with a mounting plane 30, for example a flat mounting surface 30a. The mounting surface 30a is formed on a bar 31 which connects the two sliding rails 15/16. The cross section of the bar 31 has a certain material thickness and is designed symmetrically. The bar 31 has the largest material thickness in the middle. A decrease in the material thickness towards both sides is preferably provided. The decrease in the material thickness is particularly preferably affected symmetrically in steps 32 and 33, respectively.

The base element 2a is likewise provided with a bar 34. This bar 34 connects the two supporting rails 13/14. This bar 34 also has a cross section with a material thickness which is largest in the middle. A decrease in the material thickness towards both sides is preferably provided. Here too, the decrease in the material thickness is particularly preferably affected in steps 35 and 36, respectively.

FIGS. 2a-2c each show a schematic side view of the telescopic guide 1 according to FIG. 1 implemented as a double rail. The telescopic guide is represented in the retracted state according to FIG. 2a as well as partially extended in FIG. 2b and in the maximally extended state by means of FIG. 2c.

FIG. 2a shows the two elongated telescopic elements 2 and 3 in the retracted state. That is to say the shortest possible overall length Lₘᵢₙ of the telescopic guide 1. The lower telescopic element 2 is the base element 2a and the upper telescopic element 3 is the end element 3a. Two plain bearing elements 26 and 37, which are allocated to one rail side of the double rail, are represented in their longitudinal extent, i.e., the telescopic guide has four plain bearing elements in total. A fixing means 26a, with which the plain bearing element 26 is fixed to the telescopic element 3, is represented symbolically. In contrast thereto, the plain bearing element 37 is fixed to the telescopic element 2 (base element 2a) by means of a fixing means 37a. In this way, the plain bearing element 26 is movable together with the upper telescopic element 3, i.e., with the end element 3a.

Furthermore, the end element 3a is provided with a stop means 38, which cooperates with a stop bar 39 which is provided on the base element 2a.

According to FIG. 2b, the upper telescopic element 3 is partially extended by the distance D. The plain bearing element 26 fixed thereto has moved with it by the same distance and the stop means 38 has shortened the distance from the stop bar 39.

In FIG. 2c, the telescopic guide 1, or respectively the telescopic element 3, is extended by the maximum extension length Dₘₐₓ. The stop means 38 has come into contact with the stop bar 39 and in this way limits the extension length to this maximum. Without such a limitation the extension length could reach further until the plain bearing elements 26 and 37 bump into each other. This is possible in principle but tends to be avoided for stability reasons. For the sake of safety, a certain bending strength of the entire telescopic guide 1 is guaranteed by means of the proposed limitation. In the example shown, the maximum extension length Dₘₐₓ corresponds to approximately 50% of the shortest possible overall length Lₘᵢₙ of the telescopic guide 1 shown in FIG. 2a.

FIG. 3 shows a front view of a second embodiment example of the telescopic guide according to the invention. The second embodiment comprises three telescopic elements. The upper telescopic element 3 is provided as end element 3a. It is identical to that of FIG. 1. The lower telescopic element 2 provided as base element 2a that has higher side walls 9′ and 10′ compared with FIG. 1 and a larger overall height H than that of FIG. 1. For the rest, however, it is identical to FIG. 1. For the upper and lower telescopic elements 2 and 3, in FIG. 3 identical features are marked with the same reference numbers as in FIG. 1. An additional third telescopic element 40 is formed as an intermediate element 40a. It cooperates in a sliding manner with the base element 2a located underneath and with the end element 3a located above. Again, all three telescopic elements are in each case formed as a double rail. In order that the intermediate element 40a can cooperate with the neighbouring telescopic elements 2 and 3 above and below, it is for its part provided with two double rails 41 and 42 arranged one above the other. Its lower double rail 42 has parallel sliding rails 43 and 44 which cooperate with the supporting rails of the base element 2a, whereas the upper double rail 41 is provided with parallel supporting rails 45 and 46 which cooperate with the sliding rails 15 and 16 of the end element 3a. A plain bearing element 26 is provided on the rail head 17 of the supporting rail 13 and a rail head of the supporting rail 45 of the intermediate element 40a is provided with a plain bearing element 26′ of the same type. The other symmetry side of the intermediate element 40a is provided with plain bearing elements 27 and 27′.

The intermediate element 40a is provided with a symmetrically constructed bar 47. The bar 47 is arranged at the top, with the result that its upper side 48 reaches beyond the supporting rails 45/46 of the intermediate element 40a. It connects two symmetrical side areas 49 and 50 of the intermediate element 40a. The side area 49 comprises the sliding rail 43 and, arranged above it, the supporting rail 45. The sliding rail 44 and, above it, the supporting rail 46 are provided in the side area 50. The supporting rails 45/46 belong to the upper double rail 41 of the intermediate element 40a and they are designed as raised rail heads, the design of which matches the design of the raised rail heads 13/14 of the base element of FIG. 1, to which reference is made. The sliding rails 43 and 44 belong to the lower double rail 42 of the intermediate element 40a and they are designed as rail channels, the design of which matches the design of the rail channels 15/16 of the end element 3a, which is identical to the end element 3a of FIG. 1. The mentioned bar 47 of the intermediate element 40a has three areas 47a with constant material thickness. Two areas 47b with a larger material thickness 47b are provided in between.

FIG. 4 shows a perspective view of the rear side of the second embodiment example of FIG. 3, wherein, however, only two of its telescopic elements are shown, namely the base element 2a and the intermediate element 40a. The end element has been omitted in this representation. In the perspective view, the intermediate element 40a is drawn in an extended position relative to the base element 2a. Because the rear side is shown here, the supporting rail 14 with the narrower rail head 18 is located on the left in the illustration. The gap S1 results on this side of the double rail. For the rest, the plain bearing element 27 is fixed in the sliding rail 44 and is moved with it in a sliding manner when the intermediate element 40a retracts or extends.

The details of the above-mentioned two different types of plain bearing element are described in detail below with reference to FIG. 5 and FIG. 7. FIG. 5 shows the type of plain bearing element 26 which can be seen in FIG. 4.

The plain bearing element 26 is contained in FIGS. 1-3. According to FIG. 5, it is designed as a first type of sleeve-shaped plain bearing body 51 and has a C-shaped cross section 52. An opening 53 is formed on the side of the plain bearing body 51. An inner contour 54 is also provided, which extends in an axial direction M of the plain bearing body 51. Likewise, an outer contour 55 extends in the direction of a centre axis M. The inner contour 54 and outer contour 55 are arranged concentric to each other and to a centre axis M, which creates a compact design of this plain bearing element 26.

The inner contour 54 of the plain bearing body 51 has a square cross section 56, whereby four inner bearing surfaces 56a, 56b, 56c and 56d result. Fillet-shaped depressions 57a, 57b, 57c are provided at the corners of adjoining inner bearing surfaces. The inner contour 54 is interrupted by the lateral opening 53 of the plain bearing body 51, wherein despite the interruption the cross section of the inner contour 54 is referred to, simplified, as square within the meaning of this invention. The concentrically arranged outer contour 55 has a circular cross section 58, which is likewise interrupted and despite that is referred to, simplified, as circular, or the outer contour 55 is referred to as cylindrical.

In the case of the plain bearing element 26 of FIG. 5, the inner contour 54 serves as a plain bearing surface, or respectively the four inner bearing surfaces 56a, 56b, 56c and 56d serve for the plain bearing.

The outer contour 55 is provided with a fixing means which, in the built-in state, cooperates in a positive-locking manner with a telescopic element. According to FIG. 5 the fixing means comprises ribs 59a, 59b and 59c, which protrude from the cylindrical outer contour 55 in the radial direction.

FIG. 6 shows, by means of a perspective section on the third telescopic element 40 (intermediate element 40a), a location which is provided with a complementary means which cooperates with the fixing means of the plain bearing element 26 of FIG. 5. The sliding rail 43, which is formed as a rail channel 28 with C-shaped cross section, can be seen.

The complementary means comprises a groove-like recess 60 in the rail channel 28. The recess 60 is formed to fit the radial ribs 59a-59c of the plain bearing element 26 of FIG. 5. In this way, when it is moved translationally, the telescopic element 40 can move the positive-locking plain bearing element 26 with it, as can be seen in FIG. 4.

FIG. 7 shows the second type of plain bearing element 37. The plain bearing element 37 is contained in FIGS. 2a-c. It is designed as a second type of sleeve-shaped plain bearing body 61 and has a C-shaped cross section 62. Here too, an opening 63 is formed on the side of the plain bearing body thereof. An inner contour 64 is likewise provided, which extends in the direction of a centre axis N of the plain bearing body 61, as well as an outer contour 65 which extends in the same direction.

The inner contour 64 and the outer contour 65 are arranged concentric relative to a centre axis N, with the result that this plain bearing element 37 also has a compact design.

The inner contour 64 has a square cross section 66, whereby four inner surfaces 66a, 66b, 66c and 66d result. Fillet-shaped depressions 67a, 67b and 67c are provided at the corners of adjoining inner surfaces. However, the inner surfaces do not act as plain bearing surfaces. Instead, the inner contour 64 is provided with a fixing means which, in the built-in state, cooperates in a positive-locking manner with a telescopic element. According to FIG. 7 the fixing means comprises ribs, of which the two ribs 68a and 68b are visible. They project inwards from the relevant inner surface 66a and 66b.

FIG. 8 shows, by means of a perspective section on the first telescopic element 2 (base element 2a), a location which is provided with a complementary means which cooperates with the fixing means of the plain bearing element 37 of FIG. 7. The supporting rail 14, which is formed as a raised rail head 18 with quadrilateral cross section, can be seen.

The raised rail head 18 is provided with a groove-shaped recess 69, with which the raised ribs of the plain bearing element 37 fit together in a positive-locking manner. In this way, the plain bearing element 37 is fixed to the base element 2a. The cylindrical outer contour of the plain bearing element 37 serves as a plain bearing surface when it cooperates with a sliding rail.

FIG. 9 shows a detail view according to IX in FIG. 3. The plain bearing element 26, which corresponds to that in FIG. 5, can be seen. The plain bearing element 26 has a square cross section 56 and on its inner contour 54 is provided with inner bearing surfaces 56a-d which rest in a sliding manner on the rail head of the supporting rail 45 of the intermediate element 40a. The cylindrical outer contour 55 of the plain bearing element 26 is fitted in the sliding rail 15 of the end element 3a, which is formed as a rail channel 28. The outer contour 55 has four radially protruding ribs 59a-d, which fit in a positive-locking manner into a recess 60 of the rail channel 28. The plain bearing element 26 thus slides on the rail head of the supporting rail 45 of the intermediate element 40a. The rail head has plain bearing surfaces 70a-d. The rail channel has a C-shaped cross section with an opening 71 directed substantially downwards, which coincides with the lateral opening 53 of the plain bearing element 26. The inside of the rail channel is matched to the cylindrical outer contour 55 of the plain bearing element 26. In the built-in state, the lateral opening 53 and the opening 71 leave space for the one holding arm of the intermediate element 40a which is arranged at an angle and which connects the quadrilateral cross section of the rail head of the supporting rail 45 to the intermediate element 40a in a single piece.

FIG. 10 shows a detail view according to X in FIG. 9. The view is a longitudinal section through the sliding rail 15 with plain bearing element 26 fixed therein. On its outer contour 55 the latter has fixing means in the form of the radial ribs 59a and 59c, with which it is fixed in a positive-locking manner in the sliding rail 15. The ribs 59a and 59c protrude radially on the outer contour 55 of the plain bearing element 26. The inner contour 54 of the plain bearing element 26 forms plain bearing surfaces 56a and 56c, which are arranged on the rail head of the supporting rail 45 and can slide thereon.

FIG. 11 shows a detail view according to XI in FIG. 3. The plain bearing element 37, which corresponds to that in FIG. 7, can be seen. This plain bearing element 37 sits, with the square cross section of its inner contour 64 which has four inner surfaces 66a-d, on the rail head 17 of the supporting rail 13 of the base element 2a. Its cylindrical outer contour 65 is fitted in the sliding rail 43 of the intermediate element 40a, which is formed as a rail channel. Here, the inner contour 64 of the plain bearing element 37 is provided with four ribs 68a-d, which project inwards and fit in a positive-locking manner into a recess 69, which is represented by way of example on the quadrilateral cross section of the rail head 18 according to FIG. 12. An identical recess is provided for the supporting rail 13 and the rail head 17. The sliding movement takes place between the sliding rail 43 of the intermediate element and the cylindrical outer contour 65 of the plain bearing element 37 which is fixed to the supporting rail 13 of the base element 2a.

FIG. 12 shows a detail view according to XII in FIG. 11. This view is a longitudinal section through the sliding rail 43 with the plain bearing element 37 fixed therein. On its inner contour 64 this plain bearing element has fixing means in the form of ribs 68a and 68c, which project inwards and are in a positive-locking manner with a groove-shaped recess, such as the recess 69 in FIG. 11. The plain bearing element 37 is thus fixed in a positive-locking manner to the supporting rail 13. Here, the cylindrical outer contour 65 forms a cylindrical plain bearing surface on which the sliding rail 43 can slide.

FIG. 13 shows a third embodiment example of the telescopic guide 1 according to the invention, which in turn comprises two telescopic elements 72 and 73, a base element 72a and an end element 73a. Unlike the first embodiment example, the telescopic elements of which are implemented as a double rail, however, FIG. 13 provides telescopic elements in the form of individual rails. For the rest, the structure matches one symmetry side of the embodiment example of FIG. 1.

FIG. 14 shows a fourth embodiment example of the telescopic guide 1 according to the invention, which like FIG. 3 is provided with three telescopic elements 74, 75 and 76, a base element 74a, an intermediate element 75a and an end element 76a. Unlike the first embodiment example, the telescopic elements of which are in each case implemented as a double rail, FIG. 14 involves three telescopic elements in the form of individual rails. For the rest, the structure matches one symmetry side of the embodiment example of FIG. 3.

### LIST OF REFERENCE NUMBERS

1 telescopic guide
2 telescopic element
2a base element
3 telescopic element
3a end element
4 double rail
5 double rail
6 stand
7 base plate
8 base plate
9 side wall
9′ side wall
10 side wall
10′ side wall
11 upper ledge
12 upper ledge
13 supporting rail
14 supporting rail
15 sliding rail
16 sliding rail
17 rail head
18 rail head
19 holding bar
20 crosspiece
21 holding piece
22 holding arm
23 central piece
24 connecting bar
25 holding bar
26 plain bearing element
26a fixing means
26′ plain bearing element
27 plain bearing element
27′ plain bearing element
28 rail channel
29 rail channel
30 mounting plane
30a mounting surface
31 bar
32 step
33 step
34 bar
35 step
36 step
37 plain bearing element
37a fixing means
38 stop means
39 stop bar
40 telescopic element
40a intermediate element
41 double rail
42 double rail
43 sliding rail
44 sliding rail
45 supporting rail
46 supporting rail
47 bar
47a area
47b area
48 upper side
49 side area
50 side area
51 plain bearing body
52 C-shaped cross section
53 lateral opening
54 inner contour
55 outer contour
56a-d inner bearing surface
57 fillet-shaped depression
58a-c circular cross section
59a-c rib (radial)
60 groove-shaped recess
61 plain bearing body
62 C-shaped cross section
63 lateral opening
64 inner contour
65 outer contour
66a-d inner surface
67a-c fillet-shaped depression
68a/b rib
69 groove-shaped recess
70a-d plain bearing surface
71 opening
72 telescopic element
72 a base element
73 telescopic element
73a end element
74 telescopic element
74a base element
75 telescopic element
75a intermediate element
76 telescopic element
76a end element
D distance
Dₘₐₓ extension length
H overall height
Lₘᵢₙ overall length (shortest)
M centre axis
S1 play

1. A telescopic guide (1) comprising a first elongated telescopic element (2) as a base element (2a) and second elongated telescopic element (3) as an end element (3a), and
wherein these two telescopic elements are arranged parallel to each other and are movable relative to each other in a longitudinal direction,
wherein a plain bearing is provided indirectly or directly between the first telescopic element (2) and the second telescopic element (3), wherein the plain bearing has a first plain bearing unit with at least one plain bearing element (26, 27, 26′, 27′) which can be fixed stationary to the first telescopic element (2) and is in sliding contact with the second telescopic element (3), and a second plain bearing unit with at least one plain bearing element (37) which can be fixed stationary to the second telescopic element (3), whereas the second plain bearing unit is in sliding contact with the first telescopic element (2),
wherein the plain bearing elements (26, 27, 26′, 27′, 37) are sleeve-shaped plain bearing bodies (51, 61) which have a C-shaped cross section (52, 62), and in that a lateral opening (53, 63) is formed on the plain bearing body (51, 61) by the C-shaped cross section.

2. The telescopic guide (1) according to claim 1, wherein each sleeve-shaped plain bearing body (51, 61) has an inner contour (54, 64) and an outer contour (55, 65), wherein the inner contour and the outer contour (55, 65) extend in an axial direction of the plain bearing body (51, 61), and wherein the inner contour (54, 64) and the outer contour (55, 65) are arranged concentric to each other.

3. The telescopic guide (1) according to claim 2, wherein the inner contour (54, 64) of the plain bearing body (51, 61) has a polygonal cross section.

4. The telescopic guide (1) according to claim 2, wherein the outer contour (55, 65) of the plain bearing body (51, 61) has a polygonal or circular cross section.

5. The telescopic guide according to claim 1, wherein two types of plain bearing elements are provided, which have differently designed plain bearing bodies (51, 61).

6. The telescopic guide according to claim 5, wherein the first type of plain bearing body (51) includes an inner contour (54) with a plain bearing surface and an outer contour (55) having a fixing means (59a, 59b, 59c, 59d) for a stationary fixing to one of the telescopic elements (2, 3, 40, 72, 73, 74, 75, 76).

7. The telescopic guide according to claim 6, wherein the second type of plain bearing body (61) includes an outer contour (65) with a plain bearing surface and an inner contour (64) having a fixing means (68a, 68b, 68c, 68d) for a stationary fixing to one of the telescopic elements (2, 3, 40, 72, 73, 74, 75, 76).

8. The telescopic guide (1) according to claim 7, wherein the telescopic elements (2, 3, 40, 72, 73, 74, 75, 76) have complementary means (60, 69) which are set up to cooperate with the fixing means (59a, 59b, 59c, 59d, 68a, 68b, 68c, 68d) of the plain bearing body (51, 61).

9. The telescopic guide (1) according to claim 1, wherein the opening (53, 63) of the C-shaped cross section (52, 62) of the plain bearing body (51, 61) can be temporarily enlarged by deformation of the plain bearing body (51, 61).

10. The telescopic guide (1) according to claim 1, wherein the first elongated telescopic element (2, 72, 74) provided as the base element (2a, 72a, 74a) includes a supporting rail, and the supporting rail (13, 14, 45, 46) has either a cross section with a raised rail head (17, 18) or a cross section with a rail channel (28, 29).

11. The telescopic guide (1) according to claim 10, wherein the second elongated telescopic element (3, 73, 76) provided as the end element (3a, 73a, 76a) includes a sliding rail (15, 16, 43, 44), and the sliding rail (15, 16, 43, 44) is complementary to the supporting rail (13, 14, 45, 46) of the first elongated telescopic element (2, 40) and has either a cross section with a raised rail head (17, 18) or a cross section with a rail channel (28, 29).

12. The telescopic guide (1) according to claim 11, wherein the cross section of the raised rail head (17, 18) is complementary to an inner contour (54, 64) of the plain bearing bodies (51, 61) and a cross section of the rail channel (28, 29) is complementary to an outer contour (55, 65) of the plain bearing bodies (51, 61).

13. The telescopic guide (1) according to claim 12, wherein in each case a first type of the plain bearing body (51); having the outer contour (55) of which is provided with a fixing means (59a, 59b, 59c, 59d) that serves for a stationary fixing to the respective telescopic element (3, 40), can be applied to the telescopic element (2, 40) which has the supporting rail (13, 14, 45, 46) with the raised rail head (17, 18) or the sliding rail with the raised rail head.

14. The telescopic guide (1) according to claim 13, wherein in each case a second type of the plain bearing body (61) having the inner contour (54) of which is provided with a fixing means (59a, 59b, 59c, 59d) which serves for a stationary fixing to the respective telescopic element (2, 40), can be applied to the telescopic element which having the supporting rail with the rail channel or the sliding rail (15, 16, 43, 44) with the rail channel (28, 29).

15. The telescopic guide (1) according to claim 1, further comprising at least one third elongated telescopic element (40) is an intermediate element (40a).

16. The telescopic guide according to claim 15, wherein the intermediate element (40a) comprises a sliding rail (43, 44) which cooperates with the supporting rail (13, 14) of the base element (2a) and a supporting rail (45, 46) which cooperates with the sliding rail (15, 16) of the end element (3a, 73a, 76a).

17. The telescopic guide (1) according to claim 15, wherein the telescopic elements (2, 3, 40) are in each case formed as a double rail, and in that the double rail has two parallel supporting rails (13, 14, 45, 46) and/or two parallel sliding rails (15, 16, 43, 44).

18. The telescopic guide (1) according to claim 17, wherein for the intermediate element (40a) formed as a double rail, two double rails are arranged one above the other, of which one is designed with parallel sliding rails (43, 44) and is facing towards the base element (2a) and the other is designed with parallel supporting rails (45, 46) and is facing towards the end element (3a).

19. The telescopic guide according to claim 17, wherein, in the case of a double rail, a lateral guiding can be brought about in each case between one of the parallel rails (supporting rail or sliding rail) and the corresponding plain bearing bodies (51, 61), whereas a lateral play (S1) is provided between the plain bearing bodies of the other of the parallel rails.

20. The telescopic guide (1) according to claim 1, wherein the base element (2a, 72a, 74a) is provided with a stand (6).

21. The telescopic guide according to claim 1, wherein the base element (2a) has two side elements (9, 10, 9′, 10′), and in that the side elements have a height which is sufficient to enclose the telescopic element(s) (3a, 40a) arranged above them laterally.

22. The telescopic guide (1) according to claim 21, wherein at least one of the side elements is formed as a closed side wall (9, 10, 9′, 10′).

23. The telescopic guide (1) according to claim 1, wherein the end element (3a, 73a, 76a) has a mounting plane (30) for any attachments.

24. The telescopic guide (1) according to claim 23, wherein the mounting plane (30) is a closed mounting surface (30a).

25. The telescopic guide (1) according to claim 1, wherein at least one of the telescopic elements (2, 3, 40, 72, 73, 74, 75, 76) is formed in a single piece.

26. The telescopic guide (1) according to claim 1, wherein the sleeve-shaped plain bearing bodies (51, 61), with the lateral opening (53, 63), are produced from plastic.
